(19) United States
(12) Patent Application Publication
(10) Pub. No.: US 2018/0043263 A1
(43) Pub. Date: Feb. 15, 2018

(54) Augmented Reality method and system for line-of-sight interactions with people and objects online

(71) Applicant: Emmanuel Brian Cao, Los Angeles, CA (US)

(72) Inventor: Emmanuel Brian Cao, Los Angeles, CA (US)

(21) Appl. No.: 15/675,707

(22) Filed: Aug. 12, 2017

Related U.S. Application Data
(60) Provisional application No. 62/374,917, filed on Aug. 15, 2016.

(51) Int. Cl. A63F 13/65; A63F 13/92; A63F 13/213; G06T 19/00

(52) U.S. Cl. CPC A63F 13/65; G06T 19/006; A63F 13/92; A63F 13/213

(57) ABSTRACT

Designed is a system and method for providing line of sight interaction in an AR environment between users of portable devices with the camera. The system and method uses computer-generated images to represent other system users and real or fictional objects with the precise location in 3 dimensional space. This Digital scene is overlaid onto and combined with the current real world environment as seen on the users' viewfinder. The invention is a novel system and method for allowing users to aim their portable devices and interact or communicate with the CGI images or other users of the same system, creating an augmented reality experience that is enhanced by a line of sight style communication.

### FIELD OF INVENTION

This invention relates to a system and method of communication and interaction which occur in an Augmented Reality environment. Particularly, this invention relates to a system and method by which social communication, data display, and social gameplay that occur within an Augmented Reality environment. The interaction is further applicable to social interactions such as first-person shooter style games and messaging platforms.

### BACKGROUND

Augmented reality (AR) is the direct or indirect interaction with an electronically enhanced view of real-world environment. Means of electronic enhancements can include GPS, mobile phone, computer generated objects, and accelerometers, which allow the user to interact with and digitally manipulate the AR environment. The AR environment also interacts with the real world environment of the user, thereby differing from virtual reality, which is only comprised of the electronically generated environment with no elements from the real world environment. The AR environment is usually viewed through and interacted with via an electronic display on the user's mobile device, with information about the environment and its objects overlaid onto the real world. The difference between augmented and virtual reality is well delineated in multiple patents, such as U.S. Pat. No. 8,606,657 B2, to Chesnut et al (issued Dec. 10, 2013).

“Line of Sight”, or LOS as used herein, is defined as the straight-line geometric relationship between an observing body and the observed object. More specifically herein, LOS functionality pertains to the ability of a mobile device to be aimed in the precise direction of a target object and to have the target object accurately represented in the viewfinder. The manner in which the target object is represented can be accomplished by a computer generated image that floats over the position of the target object on the viewfinder. LOS functionality requires the physical geometry of the aiming device and the target object, to include position, pitch, roll, heading and the relative orientation of detecting and target objects. “LOS interactions”, as used herein, pertain to the ability of the observing body to interact directly with a target object that it is pointed at. Since the target object is represented by a floating marker on the users' device, LOS functionality does not require the real life object to actually be captured by the viewfinder, but requires the marker that floats over the direction of the target object. For example, if a user aims their device at a target object which is obscured, the user can still interact with the associated floating marker as seen in the viewfinder.

There exists systems which contain all of the functionality of the above: LOS interaction and augmented reality overlays, but offer additional functionality. More specifically, these systems represent the AR environment on mobile systems and PDAs, such as on smartphones or tablets. These systems are usually distributed via mobile applications such as with “Pokemon GO”, and provide a service to users in which they can interact or play with other users in an augmented reality game. In “Gunman”, a mobile game by Shadowforce, users log into a local network and simulate a game of paintball with their mobile devices by using their PDAs as an aiming device, placing other users in their viewfinders crosshairs and firing. The mechanism of this type of LOS communication is based on color and albedo recognition through the video capture and image processing algorithm. In other LOS systems, the method of object recognition is based on infrared video. U.S. Pat. No. 7,204,428, issued Apr. 17, 2007, to Wilson describes a system where a coded Infrared (IR) pattern is detected by an IR camera and assigns a special marker to the object based on the IR input. However, there are certain limitations to this system. It does not contain a LOS mechanism for a massive online community of users, as it is contained within a Wi-Fi network. A massive online community interacting with each other increases the technical complexity of the system by multiple orders of magnitude. This includes servers, storage drives, high speed wired and wireless connections, software code, and other support infrastructure. This infrastructure must support a system that accurately represents an AR environment with millions of positional calculations occurring every second. These algorithms calculate positions based on integrated positional inputs from multiple sources including compass, GPS, accelerometer data and integrated navigation units.

There exists systems that contain all of the functionalities of the system described previously, namely AR environments overlaid in mobile/Wi-Fi platforms, but also with the functionality of displaying information about items in the real and artificial environment. For example, in the Yelp “Monocle” mobile application, users can see information overlaid on objects on the real world environment, such as restaurant and vendor reviews displayed over the object when it comes into view of the viewfinder. This software application is a system of associating the orientation outputs of the mobile device, such as compass, GPS location, and accelerometer data into an AR environment where objects in the real world are geographically registered. This information is combined to represent on the viewfinder information about the user environment relative to where the user is pointing the device. A number of previous patents have proffered models to present real objects in proper orientation to each other. U.S. Patent Application Publication No. US 2007/0 038 944, published Feb. 15, 2007, to Carignano et al. and U.S. Patent Application Publication No. US 2007/0 202 472, published Aug. 30, 2007, to Moritz define an augmented reality system to gather image data of a real environment, methods for generating virtual image data from the image data, means for a predefined marker object of the real environment based on the image data, and means for superimposing a set of object image data with the virtual image data at a virtual image position corresponding to the predefined marker object. However, the limitation of this system is that it does not provide a platform for communication, such as voice, text, or video. For example, the Yelp “monocle” app does not have an interface where users can spot other users that they want to interact with, and send text, video, or voice chat to the said users. In addition, systems like Yelp's “Monocle” allow users to only interact with and view AR information about stationary objects and not mobile dynamic information from moving objects and users.

Additionally, conventional methods of communication via mobile devices do not currently occur within an Augmented Reality Environment. Communication via mobile devices most commonly occurs in the following modes: voice communication, text communication, or video communication. These modes of communication, however, do not combine the usage of an AR environment. For example, when a user calls another user on a mobile device, the interaction is purely audio and no aspects of an Augmented Reality environment are present, such as computer generated images on a video display. In a video call, such as in Skype, purely video and audio aspects of telecommunication are present. There are no elements of Augmented Reality, namely an electronic overlay that interacts with the users' physical environment. Users of the conventional mode of mobile to mobile electronic communication are constrained by requiring pre-existing information about the target user they wish to communicate with, such as a phone number or username, before they can communicate electronically. They cannot communicate electronically with someone by simply viewing them in their viewfinder and choosing to communicate.

### SUMMARY

The invention combines the functionality of all of the systems mentioned above and addresses all of the shortcomings within one system. Specifically, it is a mobile software and hardware system that functions online and not in a local area network. It allows users to interact and communicate with each other in an Augmented Reality environment. More specifically, users can interact with each other as well as Computer Generated Images (CGI) objects by sending text, audio, or video communications via the mobile viewfinder. This type of interaction is known as Line of Sight (LOS) communication and is created by taking inputs from the geometry between the transmitting and target users' devices, such as GPS position, compass direction, and angle of device elevation. These inputs are used to formulate a system of aiming so that users can point their devices at one another, interact, or communicate. This system is comprised of 3 primary parts: the mobile device, the distributed software applications, and the networking server system. The software application system functions to distribute the AR environment onto the mobile interface by which the users interact in said environment. The interface includes an overlay on the mobile phone's viewfinder, represented as a plurality of the reticle to aim the device more accurately, a status display to view various information about users in the AR environment, and various CGI objects. In addition to CGI objects, other users of the system will be represented on the AR environment via floating markers. Position and orientation information about the users' devices, the other users in the system, and the CGI objects are relayed via the third part of the system which is the server. The server also functions to push software updates, to adjudicate the accuracy of the LOS interactions in the system, to maintain a library of CGI objects that can be distributed and a database of historical interactions within the system. These functionalities combine to connect users with each other in an AR environment, where they can uniquely interact by simply pointing their devices at each other. This environment can be implemented in the form of a game where users can find each other on their PDAs and “shoot” or tag each other by aiming their mobile devices at each other. In another embodiment, users can aim their devices at either strangers or their friends and communicate through their AR overlay on their devices by sending multimedia messages.

### BRIEF DESCRIPTION OF THE DRAWINGS

FIG. 1 depicts a third person view of a user operating the invention with a target user behind an obstruction

FIG. 2 depicts a first person view of the scene in FIG. 1, as seen with the AR overlay on the user's viewfinder

FIG. 3 is a depiction of users' profile page, as seen in the viewfinder once the user's marker from FIG. 2 is tapped

FIG. 4 depicts the overall system architecture of the invention, comprising of the data flow between the servers, users, and software

FIG. 5 depicts the interaction pathway, which represents the data flow of interaction attempts between users in the system

### DETAILED DESCRIPTION OF THE INVENTION

The system is comprised of a mobile device with a view finder and forward facing camera, the software application upon which the system is run, and the server network that links and distributes data between all users. “Mobile device” as used herein means any electronic device that can be one hand carry capable and is programmed to execute the method described herein (via software, firmware, or hardware code). These can include mobile phones, tables, PDAs, or laptop. Mobile devices may include one or more known storage devices, memory devices within a processor and may easily be configured as one or more software modules without departing from the invention.

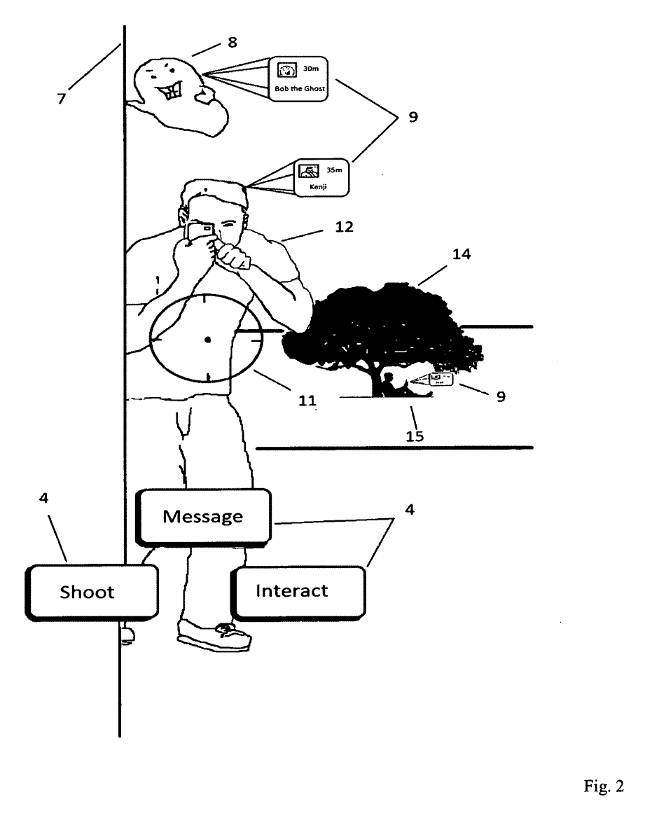

The software is an application that mobile users download onto their devices and provide a distributed framework for the invention. It creates a “heads up display” style overlay on the viewfinder through which users interact with the AR Environment as seen in one embodiment FIG. 2, with the overlay consisting of the Reticle (Object 11), the Interaction Buttons (Objects 4), and the Markers (Object 9). The software also has distributed functions, such as CGI object creation, PDA device orientation capture and Users (object) upon activating the software, relaying information about the users' position, interactions, PDA orientation, user profile information, and any other general data transfer to a common server.

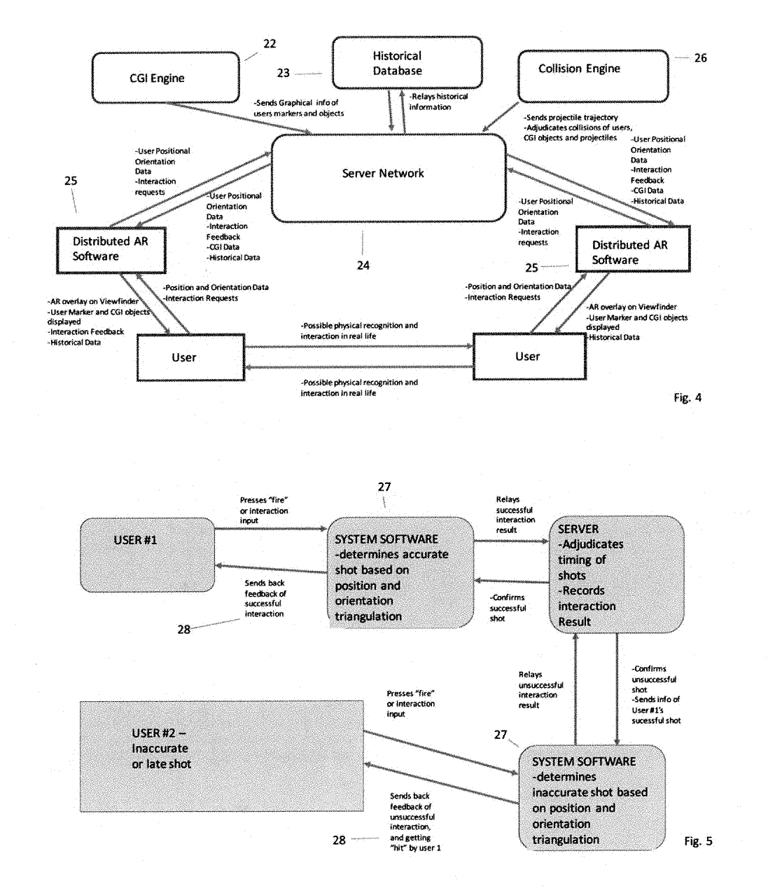

The server, for purposes of this patent, refers to the central programmable system of networking and processes that controls the data relayed to all of the distributed computers and mobile devices as seen as Object 24. It comprises of hardware and software. Its hardware component comprises of programmable computers with mass storage, high speed networking switches and routers, traffic managers, encryption boxes, multi-node processors, and network cabling. Its software component comprises of interfaces to control the data flow, administrator functions, system wide software pushing, failover, status and general system operation. There contains within the server a CGI engine as seen in FIG. 4, Object 22, the CGI engine functions to distribute CGI objects through the system via the server-user communications (FIG. 4) that can be universally seen and interacted with any users communicating with the server. In FIG. 2, CGI objects and AR environments are projected onto the individual users' viewfinders which are queued from the mobile devices' software application. Information and triggering of the CGI objects and markers was done by the server.

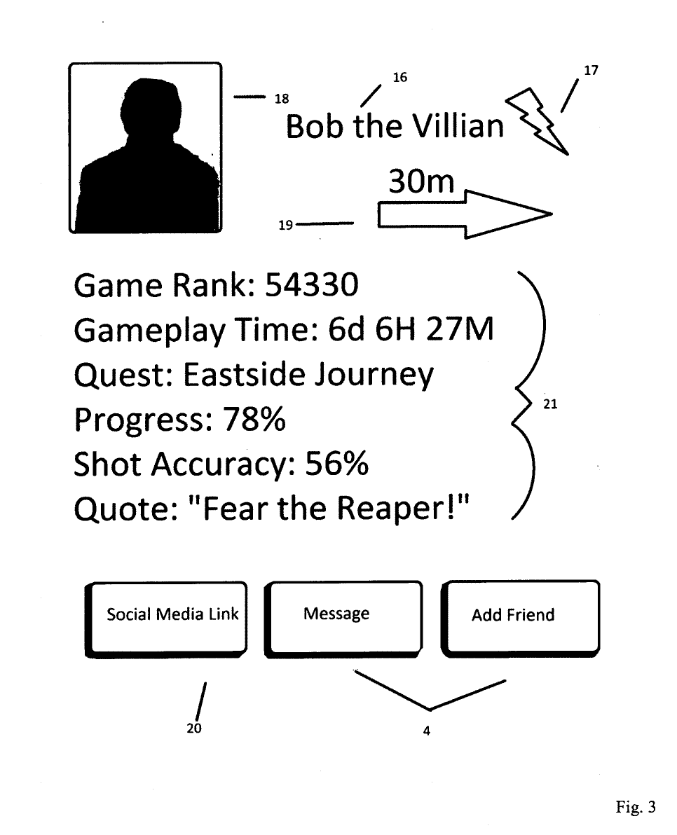

There contains within the CGI engine a computerized data library to contain the CGI objects to associate with the positioning of the object. These are called markers, which are georegistered CGI objects such as Object 8 that have an actual position in 3-D space. From this library, the marker is assigned to the particular object as well as for and other users in real life. In the most exemplary form, the profile tags will float over other users, CGI Objects, and real life objects, as depicted in the FIG. 2, Object 9. Once the user taps on this user marker, the user can now view an expanded version of the profile tag, displaying profile information such as personal links, gameplay scoring, achievements, pictures. On this expanded profile screen, the user can access interaction options, such as chatting, adding to a friend list, or reporting as seen in FIG. 3.

Another part of the system includes the system accounting, which is depicted in FIG. 4, Object 23. This system provides for a historical data base to enhance the users' experience. It provides the following functionalities: scorekeeping, message storing, friend list storage, system status, and game progress scenario, if applicable. This information is constantly relayed to all users and stored on servers.

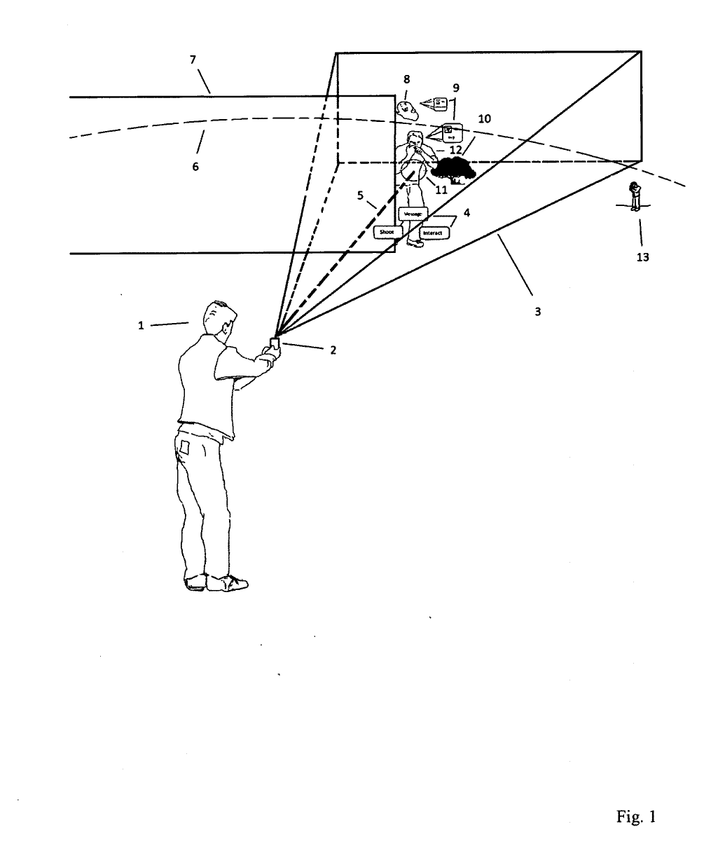

The user operates the application by activating it as seen in FIGS. 1 and 2. The user is displayed his view finder, along with an AR overlay seen in FIG. 2. The overlay in the sample screenshot is comprised of the target reticle (Object 11), the sample CGI object (Object 8), as well as the actual objects (Object 10) to view finder captures in real life, such as another person (Object 12).

The display is a function of the information processed and delivered by the software system as detailed in FIG. 4. This information is received by the common server and broadcast to other users using the software. The software application installed on each of the users' devices translates this information into computer-recognizable objects that appear on the user screen. This is displayed in FIG. 2 in which the tag (Object 9) shown, demonstrates the software system on system recognizing the position and information of another user (Object 12).

Further explained, this is accomplished as a function of triangulation, as seen in FIG. 1. A single instance of the invention ingests the position of other users (Objects 12 and 13), and relates that data to the original user position. The software then determines if the other users are visible in relation to the user (Object 1). In the embodiment seen in FIG. 1, a target user (Object 13) is able to be located within the user's radius of detection (Object 6). However, the target user is not located within the User's Field of View (Object 3); therefore, he cannot be seen as depicted in FIG. 2. This is determined by establishing a field of view, as seen in FIG. 1 (Object 3). If the target users' position is within the boundaries of the user's field of view, the target users will have an associated computer-recognizable object that can be seen on the view finder (Object 9). This determination is made by comparing the target users' position in three-dimensional space to that of the orientation of the user's device. Orientation of the user's device is comprised of its pitch, roll, and compass heading which is determined by the internal compass, accelerometer, and GPS position. Based on this comparison, the system will accurately represent the three-dimensional location of the target users on the user's view finder via a marker as seen in object. This is demonstrated in Figure which shows the Field of View (Object 3) in FIG. 1. This positional and orientation information is shared among all users on the server, so all of the devices operating the system software will be able to see multiple user positions.

CGI objects are made visible (Object 8) in the same manner, with the difference being the CGI engine (figure one object) generates a three-dimensional position for the CGI object, and is distributed to all users operating system software.

The reticle (Object 11) is used for fine aiming of the device to interact with the target users. If the computer-recognized target object moves under the reticle, and the user chooses to interact, then the connection is successful as depicted by Object 5. If the target user is outside the reticle and the user decides to interact, the interaction is unsuccessful. The collision engine (Object 26) is incorporated here, in order to determine as accurately as possible real world flight paths of objects that are “shot” from the originating user. This is used in such scenarios as a projectile that drops after it is fired.

Once any interaction button is pressed on the AR interface from FIG. 1(Object 4), it initiates the interaction pathway as seen in FIG. 5. The software system (Object 27) contained within the device determines whether the interaction was successful or not and provides feedback to the user. The feedback may come in the form of a message notifying user has missed if the interaction was unsuccessful (Object 28). The interaction attempt, if successful, this is relayed to the server (Object 22) and then relate to the target user. If it was a CGI target that the user engaged, the successful interaction is related to all users so that all users can see the CGI object is being engaged. The target users receive notification of a successful interaction. For example, in a first person shooter scenario, the target user received notification that they were shot at by the regional user. In-game effects such as scoring provide feedback and tracking for these types of interactions, as well as a basis for gaming competition. In the messaging scenario, the target user would only receive the message if the interaction loop was successful.

In addition to positional and orientation data being distributed through the user base, timestamps are distributed along with the data in order to resolve positional issues. Timestamps associated with position and orientation data will more accurately resolve relational movement and interaction accuracy of users within the group. For example, if two users at target and “Shoot” each other at roughly the same time, the user software will resolve who shot first according to the timestamp of both users' data.

In the most exemplary version of the system, the system would be delivered via a mobile phone application, and once initiated, users interact with each other and CGI objects in an AR environment. Users can view the exact locations and detailed information of either their own friends or any users of the application, and can customize their visibility to the online community as well. AR CGI objects may be anything that the software developers can make that enhance the play of the users, such as monsters or power ups that users can interact with. The methods of interaction can vary, such as shooting other players or CGI objects in the AR environment, or sending multimedia data to other players that they see in the viewfinder. In another version of this embodiment, users would participate in a massive online first person shooter game immersed in an AR Environment. In another version of this embodiment, users would participate in mass quest with a storyline that requires travelling to different locations. In the game-mode, users of the system can participate in quests by themselves or with other players, and achieve points which can build credit, which in turn can be used to make in-app purchases.

In another embodiment, which can be implemented in the previous embodiment as well, users can send multimedia messages by aiming the phone reticle at any other users in the online community and initiating communication, such as by pressing a messaging button (Object 4). This function would allow complying users to interact with each other even though they have never met. There would be a marker associated with each user that once tapped will display more detailed information such as user name (Object 16), profile picture (Object 18), in-game information (Object 21), relative location (Object 19), social media profile links (Object 20), avatar (Object 17), etc. In a version of this embodiment, users would be able to select a private mode, in which users can only view and interact with people they know, and conversely be seen or interacted with by people they have on their friend list, which they modify themselves.

In another embodiment, the invention can serve as a friend locator that finds and depicts on the AR overlay where the users' friends are.

### CONCLUSION

The disclosed embodiments are illustrative, not restrictive. While specific configurations of the invention have been described, it is understood that the present invention can be applied to a wide variety of Augmented Reality systems. There are many alternative ways of implementing the invention.

1-13. (canceled)

14. A system for users to interact with each in an Augmented Reality environment by pointing and aiming their mobile devices at one another, known as line-of-sight interactions, and said system comprising:
a) smart mobile devices that contain a i) forward facing camera; ii) a viewfinder; and iii) processing computer
b) distributed software applications to be implemented on the mobile devices in a)
c) programmable servers that i) tracks and distributes all user positions and orientations relative to each other; and ii) provide connectivity between all mobile devices and AR system

15. The system of claim 14, wherein LOS Interactions are created by communicating orientation, position, and interaction information between servers and mobile devices

16. The system of claim 14, wherein the medium of interaction is a mobile AR game that is based on LOS style interactions

17. The system of claim 14, wherein a messaging platform in which users of the invention can send multimedia messages by aiming their devices at target users

18. The system of claim 14, wherein the software interface comprises of an overlay on the user viewfinder in order to interact and view information about the AR environment

19. The system for claim 18, wherein the overlay comprises of a reticle on the overlay to allow for the fine aiming of the mobile device

20. The system for claim 14, wherein the server distributes CGI objects from the AR environment

21. The system for claim 20, wherein the server contains a library of CGI images that are accurately georegistered in three-dimensional space

22. The system for claim 21, wherein a library of markers is applied to active users of the system, so that they appear to float over their position as seen in the mobile overlay

23. The system for claim 14, wherein users receive feedback notifications for any type of LOS interactions

24. The system for claim 23, wherein system interactions are scored and recorded

25. The system for claim 24, wherein users' progress and application progress is recorded and builds upon in the embodiment of the system

26. The system for claim 17, wherein users modify their visibility in the AR Environment
